(19) United States
(12) Patent Application Publication
(10) Pub. No.: US 2017/0190369 A1
(43) Pub. Date: Jul. 6, 2017

(54) BIKE RETENTION DEVICE, AND RELATED SYSTEMS AND METHODS

(71) Applicant: Sportworks Northwest, Inc., Woodinville, WA (US)

(72) Inventors: Eric L. Rayl, Woodinville, WA (US); Gerald M. Stewart, Seattle, WA (US)

(21) Appl. No.: 15/397,479

(22) Filed: Jan. 3, 2017

Related U.S. Application Data
(60) Provisional application No. 62/274,074, filed on Dec. 31, 2015.

(51) Int. Cl. B62H 3/08

(52) U.S. Cl. CPC B62H 3/08

(57) ABSTRACT

A device for holding a cycle includes a first frame operable to hold a wheel of a cycle when the wheel is inserted into the frame, a second frame coupled with the first frame, and a lock coupled with the second frame. The second frame is moveable relative to the first frame to a first position and to a second position. When the second frame is in the first position, one may insert the cycle's wheel into the first frame. When the second frame is in the second position and the cycle's wheel has been inserted into the first frame, the second frame holds the cycle's wheel in the first frame. The lock is coupled with the second frame such that the lock contacts the cycle's wheel when the cycle's wheel is being inserted into the first frame and the second frame moves toward the second position. The lock is configured to: a) allow the insertion of the cycle's wheel into the first frame when the second frame moves toward the second position, and b) resist the withdrawal of the cycle's wheel out of the first frame when the second frame is in the second position.

### CROSS REFERENCE TO RELATED APPLICATION AND CLAIM OF PRIORITY

This application claims priority from commonly owned U.S. Provisional Patent Application 62/274,074 filed 31 Dec. 2015, and titled “Quick Load Bicycle Rack for Vehicles with Improved Retention”, presently pending and incorporated by reference.

### BACKGROUND

Bicycles are a very popular and convenient means of transportation. Many people living in an urban environment prefer riding a bicycle to driving a car because driving and parking a car in a city can be expensive and a real hassle. In large or expansive cities, many people use mass transportation, such as a bus or a train, to get close to their specific destination, and then ride their bicycle to their final, specific destination.

Unfortunately, many busses and trains are not well equipped to transport many of their rider's bicycles. The equipment used to a hold rider's bicycle is often difficult to operate, which makes inserting one's bicycle into the holder difficult. One typically has to operate the bike holder with one's hand while inserting one's bike. And if the bike holder is designed to allow one to insert one's bicycle without operating the holder with one's hand, then the holder often fails to securely hold the bicycle. In addition, some busses and trains can transport a few bicycles at the same time but this number is a small percentage of the total number of riders that the bus or train can transport at the same time. So, many people either avoid mass transportation and ride their bicycle most if not all of the way to their specific destination. Or, many people use mass transportation and either walk or taxi to their final, specific destination.

Thus, there is a need for a device that can easily hold a bicycle in a bus or train while the owner of the bicycle rides the bus or train, and that holds the bicycle without consuming much space on the bus or train.

### SUMMARY

In an aspect of the invention, a device for holding a cycle includes a first frame operable to hold a wheel of a cycle when the wheel is inserted into the frame, a second frame coupled with the first frame, and a lock coupled with the second frame. The second frame is moveable relative to the first frame to a first position and to a second position. When the second frame is in the first position, one may insert the cycle's wheel into the first frame. When the second frame is in the second position and the cycle's wheel has been inserted into the first frame, the second frame holds the cycle's wheel in the first frame. The lock is coupled with the second frame such that the lock contacts the cycle's wheel or fender when the cycle's wheel is being inserted into the first frame and the second frame moves toward the second position. The lock is configured to: a) allow the insertion of the cycle's wheel into the first frame when the second frame moves toward the second position, and b) resist the withdrawal of the cycle's wheel out of the first frame when the second frame is in the second position.

With the device mounted in a bus or train, one can quickly and easily store one's cycle in the bus or train while one rides the bus or train. The lock does not resist the rolling of the cycle's wheel into the first frame, but does resist the rolling of the cycle's wheel in the opposite direction. Thus, the lock allows one to easily and quickly roll the wheel of one's cycle into the first frame so that the device holds the cycle, and resists the withdrawal of the wheel out of the first frame. In addition, because the lock resists the rotation of the cycle's wheel in a direction that would cause the wheel to withdraw from the first frame, the lock does not need to extend over the wheel's hub to hold the wheel in the first frame.

In another aspect of the invention, a method for holding a cycle includes: a) moving a second frame of a device, which is coupled to a first frame of the device, to a first position to allow a wheel of a cycle to be inserted into the first frame; b) moving the second frame of the device to a second position to hold the cycle's wheel in the first frame; c) when moving the second frame toward the second position, contacting the cycle's wheel or fender with a lock of the device that is coupled with the second frame; d) while the lock contacts the cycle's wheel, allowing the cycle's wheel to be inserted into the first frame; e) urging the lock against the cycle's wheel when the second frame is in the second position; and f) with the lock, resisting the withdrawal of the cycle's wheel from the first frame.

### BRIEF DESCRIPTION OF THE FIGURES

FIG. 1 shows a perspective view of a device for holding a cycle, according to an embodiment of the invention.

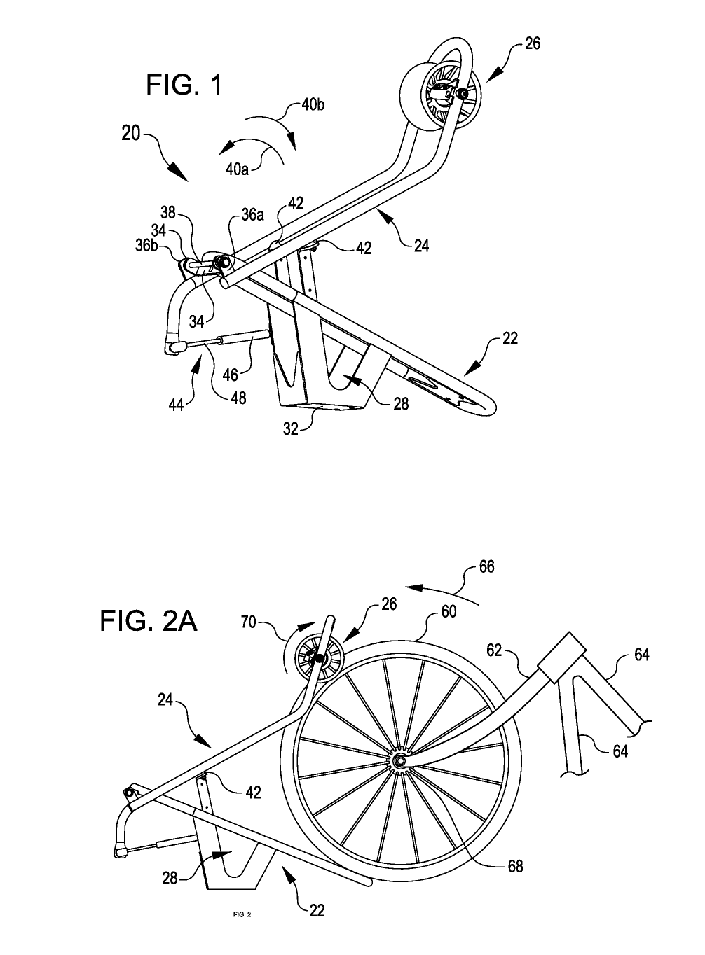

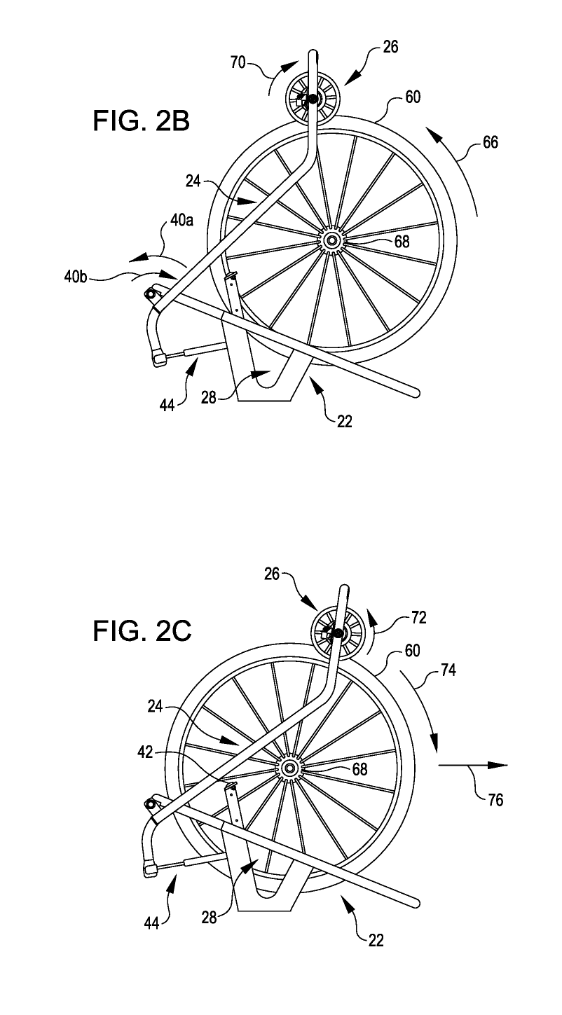

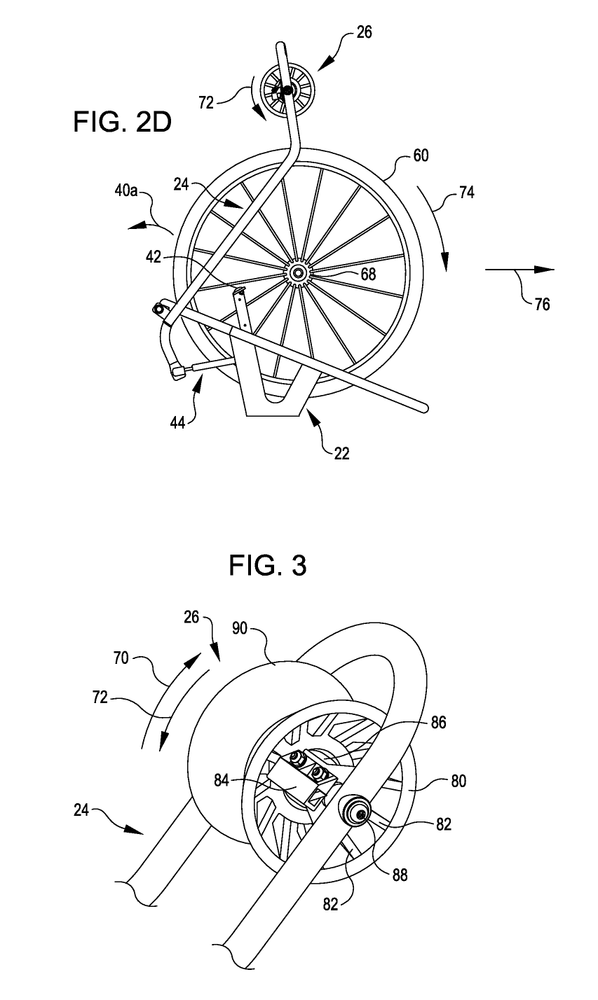

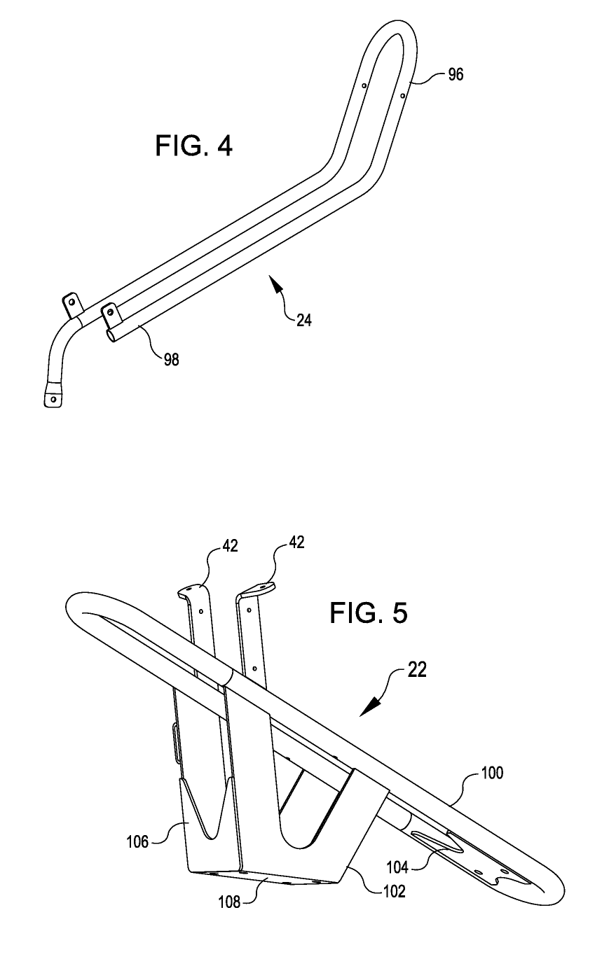

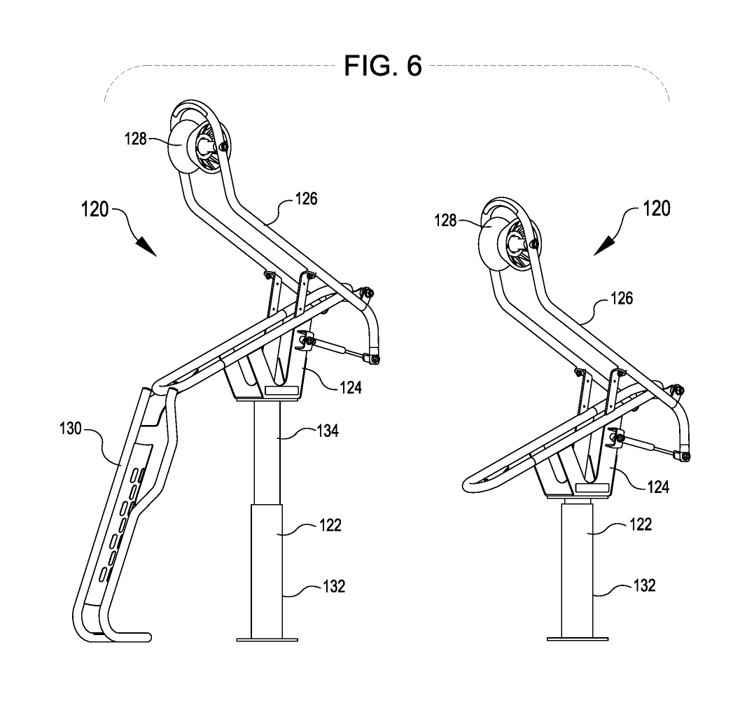

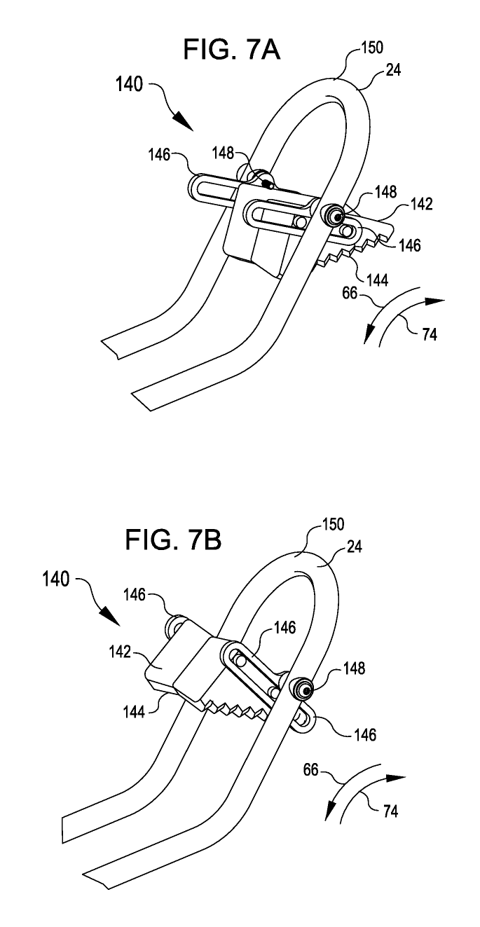

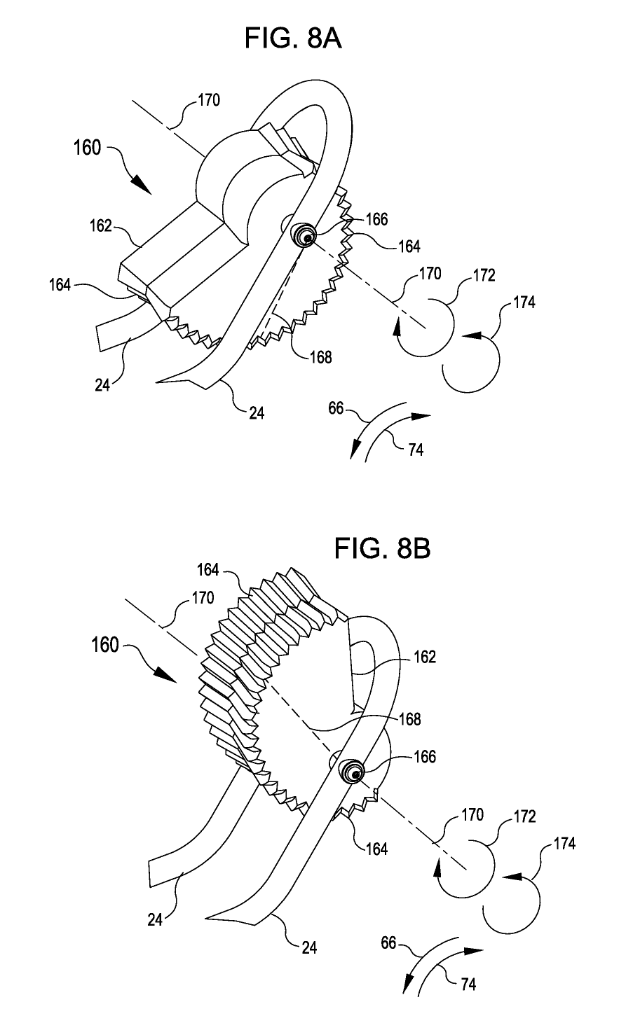

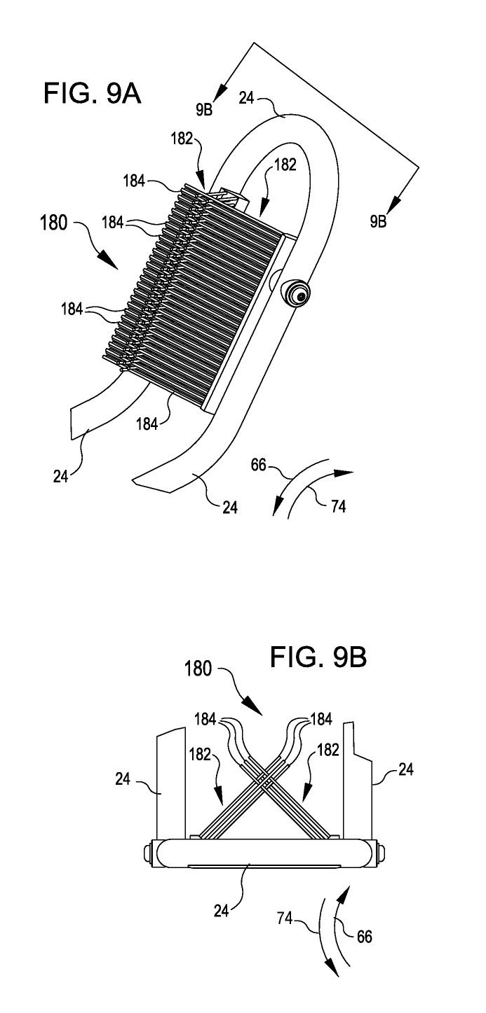

Each of FIGS. 2A-2D shows a side view of the device shown in FIG. 1 as a cycle's wheel is inserted into the device, each according to an embodiment of the invention. FIG. 2A shows the device with the cycle's wheel about to be inserted. FIG. 2B shows the device with the device's second frame in the first position to allow the cycle's wheel to drop into the device's first frame. FIG. 2C shows the device with the device's second frame in the second position to hold the cycle's wheel in the device's first frame. FIG. 2D shows the device with the device's second frame in a position that allows the cycle's wheel to be withdrawn from the device's first frame.

FIG. 3 shows a perspective view of the lock of the device shown in FIGS. 1-2D, according to an embodiment of the invention.

FIG. 4 shows a perspective view of the second frame of the device shown in FIGS. 1-2D, according to an embodiment of the invention.

FIG. 5 shows a perspective view of the first frame of the device shown in FIGS. 1-2D, according to an embodiment of the invention.

FIG. 6 shows two perspective views of a device, each according to another embodiment of the invention.

Each of FIGS. 7A and 7B shows a perspective view of another lock, according to an embodiment of the invention.

Each of FIGS. 8A and 8B shows a perspective view of yet another lock, according to an embodiment of the invention.

Each of FIGS. 9A and 9B shows a view of still another lock, according to an embodiment of the invention.

### DETAILED DESCRIPTION

FIG. 1 shows a perspective view of a device 20 for holding a cycle (not shown), according to an embodiment of the invention. The cycle may be any cycle such as a tricycle and a unicycle, but most often will be a bicycle. The device 20 includes a first frame 22, a second frame 24 coupled to the first frame 22, and a lock 26 coupled to the second frame 24. The first frame 22 (discussed in greater detail in conjunction with FIG. 5) includes a cavity 28 into which a wheel (shown in FIGS. 2A-2D) of a cycle may be inserted when one uses the device 20 to hold one's cycle. Here, wheel includes the component that contacts the road when one rides the cycle, such as an inflatable tire. The second frame 24 (discussed in greater detail in conjunction with FIG. 4) is movable relative to the first frame 22 to a first position (shown in FIG. 2B) and to a second position (shown in FIG. 2C). As discussed in greater detail in conjunction with the FIGS. 2A-2D, in the first position, the second frame 24 locates the lock 26 out of the wheel's way to allow one to insert the cycle's wheel into the cavity 28 of the first frame 22. In the second position, the second frame 24 locates the lock 26 adjacent the wheel and holds the cycle's wheel in the cavity 28. When the second frame 24 moves toward the second position as one inserts the cycle's wheel into the first frame 22, the lock 26 (discussed in greater detail in conjunction with FIGS. 3 and 7A-9) contacts the cycle's wheel or fender and allows the cycle's wheel to roll into the first frame's cavity 28, but resists the roll of the cycle's wheel in the opposite direction or out of the cavity 28.

With the device 20 mounted in a bus or train, one can quickly and easily store one's cycle in the bus or train while one rides the bus or train. Because the lock 26 allows the cycle's wheel to roll into the first frame's cavity 28, one can quickly and easily insert the cycle's wheel into the first frame's cavity 28 to hold one's cycle. And, because the lock 26 resists the roll of the cycle's wheel out of the first frame's cavity 28, and because the second frame 24 holds the wheel in the first frame 22, the wheel, and thus the cycle, may be securely held by the device 20 when the bus or train experiences a sudden jolt from a bump or sharp turn. In addition, because the lock 26 resists the roll of a cycle's wheel in a direction that would cause the wheel to withdraw from the first frame 22, the second frame 24 does not need to extend the lock 26 over or past the wheel's hub to hold the wheel in the first frame 22.

The device 20 may be mounted in a bus or train in any desired manner. For example, in this and other embodiments the device's first frame 22 is mounted to the floor of the bus or train that passengers walk and stand on while riding the bus or train. More specifically, the bottom 32 of the first frame 22 is bolted to the bus or train's floor. In other embodiments, the device 20 includes a pedestal (shown and discussed in greater detail in conjunction with FIG. 6) that locates the bottom 32, and thus the device 20, a distance above the bus or train's floor. This may be desirable to reduce the footprint of the device 20 and the cycle it holds, on the bus or train's floor and allow more room for passengers to walk or stand on the bus or train's floor, or for seats to be located.

The device's second frame 24 may be coupled with the device's first frame 22 in any desired manner that allows the second frame 24 to move relative to the first frame 22 to the first and second positions. For example, in this and other embodiments the second frame 24 is pivotally coupled to the first frame 22. More specifically, the first frame 22 includes a bracket 34, the second frame 24 includes two tabs 36a and 36b, and the device 20 includes a pin 38. Each of the bracket 34 and the tabs 36a and 36b includes a hole that is sized to receive the pin 38 and to allow the tabs 36a and 36b to rotate relative to the pin 38. The pin 38 extends through the holes in the bracket 34 and each of the tabs 36a and 36. In this configuration, the second frame 24 may be rotated relative to the first frame 22 in the directions indicated by the arrows 40a and 40b to move the second frame 24 toward the first position (FIG. 2B) and toward the second position (FIG. 2C). When the second frame 24 is pivoted in the direction indicated by the arrow 40a, the second frame 24 moves toward the first position. When the second frame 24 is in the first position and is pivoted in the direction indicated by the arrow 40b, the second frame 24 moves toward the second position. The first frame 22 also includes two stops 42 that limit the movement of the second frame 24 in the direction indicated by the arrow 40b and keeps the device 20 ready to receive a cycle's wheel.

Other embodiments are possible. For example, the second frame 24 may not be pivotally coupled to the first frame 22, but rather coupled such that the second frame 24 slides relative to the first frame 22. In other words, the second frame 24 may not rotate relative to the first frame 22, but rather translate relative to the first frame 22. As another example, the second frame 24 may be coupled with the first frame 22 such that the second frame 24 may rotate and translate relative to the first frame when the second frame 24 is moved relative to the first frame 22.

The lock 26 may be coupled with the second frame 24 in any desired manner. For example, in this and other embodiments the lock 26 is bolted to an end of the second frame 24 and may not be relocated along the second frame 24 closer or farther away from the second frame's tabs 36a and 36b. In other embodiments, the lock 26 may be releasably coupled with the second frame 24 to allow one to relocate the lock 26 closer or farther away from the tabs 36a and 36b. This may be desirable to allow the device 20 to hold a wheel having a diameter much shorter than 26 inches.

Still referring to FIG. 1, the device 20 also includes a spring 44 coupled to the first frame 22 and the second frame 24 to bias the second frame 24 toward the second position. The spring 44 may be any desired spring capable of providing the desired bias of the second frame 24 toward the second position. For example, in this and other embodiments, the spring 44 is a gas spring that uses compressed gas within a cylinder to exert force (here fifteen pounds) on a piston. The cylinder portion 46 of the gas spring 44 is coupled to the first frame 22, and the piston portion 48 of the gas spring 44 is coupled to the second frame 24. When the second frame 24 is moved toward the first position (FIG. 2B) the piston portion 48 of the gas spring 44 compresses the gas inside the cylinder portion 46 causing the pressure inside the cylinder portion 48 to increase. This, in turn, causes the piston portion 48 to exert more force on the second frame 24 and thus bias the second frame 24 against the first frame's stops 42 and toward the second position (FIG. 2C).

Other embodiments are possible. For example, the spring 44 may be a coiled torsion spring coupled with the first frame's bracket 34 and one or more of the second frame's tabs 36a and 36b. As another example, the spring 44 may be a coiled compression spring. In addition, the spring 44 may include any combination of two or more of a gas spring, torsion spring and compression spring, tension spring, leaf spring, and an elastomer in tension, compression or torsion.

Each of FIGS. 2A-2D shows a side view of the device 20 shown in FIG. 1 as a cycle's wheel 60 is inserted into the device 20, each according to an embodiment of the invention. The cycle's wheel 60 shown in each of FIGS. 2A-2D is the front wheel of a bicycle. FIG. 2A also shows the bicycle's fork 62 and a portion of the bicycle's frame 64, but these components of the bicycle have been omitted from FIGS. 2B-2D. Also, although FIGS. 2A-2D show the insertion of the bicycle's front wheel 60 into the device 20, one may insert the rear wheel of a bicycle into the device 20 to have the device 20 hold the bicycle.

FIG. 2A shows the device 20 with the wheel 60 about to be inserted. In this and other embodiments, the wheel 60 lies on top of an end of the first frame 22 and contacts the lock 26. One may roll the wheel 60 up to this position, or one may lift the wheel 60 off the ground and place the wheel 60 into this position. At this stage, the second frame 24 rests on the stops 42. To insert the wheel 60 into the cavity 28 of the first frame 22, one rolls the wheel 60 toward the stops 42. This causes the wheel 60 to rotate in the direction indicated by the arrow 66 about the wheel's hub 68. As the wheel 60 moves toward the stops 42, the wheel 60 moves the second frame 24 away from the first frame 22, toward the first position shown in FIG. 2B. While the wheel 60 moves toward the first frame's stops 42, the lock 26 maintains contact with the wheel 60. So, to allow the wheel 60 to move toward the stops 42, the lock 26 rotates in a first direction indicated by the arrow 70. To allow one to easily insert the wheel 60 into the first frame 22, the lock 26 rotates in this first direction with little resistance or drag.

Other embodiments are possible. For example, the lock 26 may not contact the wheel while the wheel 60 is moved toward the stops 42—i.e. while the second frame 22 moves toward the first position—but instead may contact the wheel 60 at a moment in time when the wheel 60 moves toward the stops 42. More specifically, “while the second frame 22 moves toward the first position” means during the whole period that the second frame 22 moves to the second position, and “when the second frame 22 moves toward the first position” means at one or more moments during the period that the second frame 22 moves toward the first position. In other words, the lock 26 may contact the wheel 60 at the beginning of this stage (as shown in FIG. 2A) but then the second frame 24 may be moved to the first position by one's hand or another component of the device without the wheel contacting the lock 26. As another example, the lock 26 may not contact the wheel 60 at all during this stage of the insertion process.

FIG. 2B shows the device 20 with the device's second frame 24 in the first position. In this and other embodiments, the first position of the second frame 24 is the position at which the wheel 60 begins to drop into the first frame's cavity 28. More specifically, when the second frame 24 is in the first position and the wheel 60 continues to roll in the direction of the arrow 66, the wheel 60 no longer moves the second frame 24 in the direction indicated by the arrow 40a. Instead, as the wheel 60 drops into the cavity 28, the spring 44 moves the second frame 24 in the direction indicated by the arrow 40b, toward the second position. While the second frame 24 moves toward the second position, the lock 26 contacts the wheel 60 and continues to rotate in the direction indicated by the arrow 70.

Thus, the first position of the second frame 24 depends on the size of the wheel 60 being inserted into the first frame 22. For a large-diameter wheel 60, such as wheel 60 having a 29-inch diameter, the second frame's first position locates the lock 26 farther away from the first frame's cavity 28 than a wheel having a 26-inch diameter or a wheel having 16-inch diameter. Likewise, the second frame's second position also depends on the size of the wheel 60 being held in the first frame 22 because the second position is the position at which the lock 26 contacts the wheel 60 after the wheel 60 has been inserted into the first frame's cavity 28.

Other embodiments are possible. For example, the lock 26 may contact the wheel 60 when the second frame 24 moves toward the second position—i.e. at a moment in time during the period that the second frame moves to the second position.

FIG. 2C shows the device 20 with the device's second frame 24 in the second position. The second position is the position in which the second frame 24 holds the wheel in the first frame 22 by resisting the movement of the wheel 60 up, out of the first frame's cavity 28. To do this the device's spring 44 forces the second frame 24 toward the first frame's stops 42, which urges the lock 26 against the wheel 60. The second position is also the position in which the lock 26 resists the rolling of the wheel 60 out of the first frame's cavity 28. To do this, the lock 26 resists rotation in a second direction indicated by the arrow 72, which is opposite the first direction indicated by the arrow 70 in FIGS. 2A and 2B. This resistance in the second direction 72 resists the rotation of the wheel 60 in the direction indicated by the arrow 74, and thus resists the rolling of the wheel 60 out of the first frame's cavity 28, which may be caused by one inadvertently pulling the cycle in a direction indicated by the arrow 76 or the inertia of the cycle generating a force in the direction 76 as the bus or train turns a corner. With the wheel 60 in the cavity 28 and the second frame 24 in the second position, the wheel 60, and thus the cycle that the wheel 60 is a part of, is held by the device 20.

Other embodiments are possible. For example, the lock 26 may not rotate at all in the direction indicated by the arrow 72 to provide more security against the wheel 60 rolling in the direction indicated by the arrow 74. As another example, in the second position, the second frame 24 may not locate the lock 26 over or past the wheel's hub 68 as shown in FIG. 2C, but may instead locate the lock 26 left of the wheel's hub 68. In such embodiments, the lock 26 and second frame 24 can hold the wheel 60 in the first frame's cavity 28 because the lock 26 resists the rolling of the wheel 60 in the direction 74, and the spring 44 urges the lock 26 against the wheel 60 as the wheel 60 attempts to move relative to the lock 26.

FIG. 2D shows the device 20 with the device's second frame 24 in a third position that allows the cycle's wheel 60 to be withdrawn from the device's first frame 22. In the third position, the second frame 24 locates the lock 26 away from the wheel 60 such that the lock 26 does not contact the wheel 60 as the wheel 60 is rolled out of the first frame's cavity 28. In this and other embodiments, one pushes the second frame 24 in the direction indicated by the arrow 40a. When the second frame 24 is in this third position, one can then pull the cycle in the direction indicated by the arrow 76 to roll the wheel 60 in the direction indicated by the arrow 74 to withdraw the wheel 60 from the cavity 28. If the lock 26 is configured to substantially resist rotation in the direction indicated by the arrow 72 or to not rotate at all in the direction 72, then moving the second frame 24 to the third position may be needed to remove the wheel 60 from the device 20. If, however, the lock is configured to moderately or lightly resist rotation in the direction 72 and the spring 44 moderately or lightly urges the second frame 24 toward the stops 42, then one may be able to withdraw the wheel 60 from the device 20 by pulling in the direction 76 and having the wheel 60 move the second frame 24 toward the first position.

Similar to the first and second positions, the third position of the second frame 24 depends on the size of the wheel 60 held by the first frame 22. For a large-diameter wheel 60, such as wheel 60 having a 29-inch diameter, the second frame's third position locates the lock 26 farther away from the first frame's cavity 28 than a wheel 60 having a 26-inch diameter or a wheel 60 having 16-inch diameter.

FIG. 3 shows a perspective view of the device's lock 26 shown in FIGS. 1-2D, according to an embodiment of the invention. As previously mentioned, the lock 26 is configured to rotate in the direction indicated by the arrow 70, and resist rotation in the direction indicated by the arrow 72. In this manner, the lock 26 allows a cycle's wheel to roll into the first frame's cavity 28, but resists the roll of the cycle's wheel in the opposite direction or out of the cavity 28.

The lock 26 may be configured as desired to provide this function. For example, in this and other embodiments, the lock 26 includes a contact wheel 80, a sprocket 82, and a pawl 84 that engages the sprocket 82 and allows the sprocket 82 to rotate in the direction 70 but prevents the sprocket 82 from rotating in the direction 72. The contact wheel 80 and the sprocket 82 are integral with each other. More specifically, the contact wheel 80 and the sprocket 82 are made from the same, single block of material. To allow the contact wheel 80 and sprocket to rotate in the direction 70, the contact wheel 80 and sprocket 82 include a hub 86 through which the bolt 88 passes as it extends across the second frame 24. A nut (not shown) threadingly engages the bolt 88 to couple the contact wheel and sprocket with the second frame 24. The pawl 86 is mounted adjacent the sprocket 82 and to the second frame 24 so that when the pawl 84 engages the sprocket 82, the sprocket 82 and thus the contact wheel 80 are prevented from rotating in the direction 72. To allow the sprocket 82, and thus the contact wheel 80, to rotate in the direction 70, the pawl 82 includes a surface (not shown) that contacts the sprocket 82 when the sprocket 82 rotates in the direction 70. The surface is sloped so that when the sprocket 82 contacts it the pawl 84 is urged out of the sprocket's way. To allow the pawl 84 to move out of the sprocket's way and then move the pawl 84 back into a position to make contact with the sprocket again as the sprocket continues to rotate, the pawl 84 includes a spring (not shown). To prevent the sprocket from rotating in the direction 72, the pawl 84 includes another surface (not shown), opposite the sloped surface, that is not sloped such that when the sprocket 82 contacts this surface the pawl 84 does not move out of the sprocket's way, and thus jambs the sprocket 82.

Other embodiments are possible. For example, the lock 26 may not prevent the rotation of the contact wheel 80 in the direction 72 but rather may resist the rotation by making it harder to rotate the contact wheel in the direction 72 than in the direction 70. This may be done by including a clutch mechanism inside the hub of the contact wheel 80 that allows the contact wheel to freely rotate in the direction 70 and uses friction to resist rotation in the direction 72.

The contact wheel 80 also includes a surface 90 that contacts the cycle's wheel when the wheel is inserted into the cavity 28 of the device's first frame 22 (FIGS. 1-2D). In this and other embodiments, the surface 90 is V-shaped to increase the friction between the wheel's tire and the surface 90 so that the lock's contact wheel 80 won't easily slip while the lock contacts the wheel. With the “V” shape the contact wheel 80 may also contact a fender that covers a wheel when the wheel with the fender is inserted into the device 20 (FIGS. 1-2D), instead of the wheel's tire, and hold the fender and wheel.

FIG. 4 shows a perspective view of the second frame 44 of the device shown in FIGS. 1-2D, according to an embodiment of the invention. The second frame 24 may include any desired material and may be configured into any desired shape capable of locating the lock 26 as desired when the second frame 24 is in the first and second positions, and capable of withstanding the loads that the second frame 24 will experience during use. For example, in this and other embodiments, the second frame 24 is made from 304 stainless steel tubing having an outside diameter of 0.875 inches and a wall thickness of 0.065 inches. The second frame 24 is formed into a loop that includes a first end 96 where the lock 26 is coupled to the second frame 24, and a second end 98 where the first frame 22 is coupled to the second frame 24.

Other embodiments are possible. For example, the second frame 24 may be formed into a hook, instead of loop, with the lock 26 coupled to the end of the frame 24 that forms the hook and the other end of the frame 24 coupled to the first frame 22.

FIG. 5 shows a perspective view of the first frame 22 of the device 20 shown in FIGS. 1-2D, according to an embodiment of the invention. The first frame 22 holds the wheel 60 (FIGS. 2A-2D) and together with the second frame 24 secures the wheel 60 in the device 20. The first frame 22 also supports the second frame 22 while the second frame moves toward the first and second positions.

The first frame 22 may include any desired material and may be configured into any desired shape capable of performing these functions. For example, in this and other embodiments, the first frame 22 includes a loop 100 and a basket 102. The loop 100 is made from 304 stainless steel tubing having an outside diameter of 0.875 inches and a wall thickness of 0.065 inches. The basket 102 is made from 304 stainless steel sheet having a thickness of 0.120 inches. Together, the loop 100 and the basket 102 form a cavity 28 in which a portion of the wheel is inserted when the first frame 22 holds the wheel. The loop 100 includes a wheel-stop 104 that contacts the wheel when the wheel is in the cavity 28 and the second frame 24 is in the second position holding the wheel in the cavity 28. The basket 102 also includes a wheel stop 106 that also contacts the wheel when the wheel is in the cavity 28 and the second frame 24 is in the second position holding the wheel in the cavity 28. In other words, when the wheel is in the cavity 28 the wheel does not contact the bottom 108 of the basket 102. However, if the wheel is large, then the wheel may only contact the wheel stop 104 and the end of the loop 100 that is away from the stop 104. The first frame 22 also includes the two stops 42 that limit the movement of the second frame 24 toward the loop 100. The two stops 42 are adjustable in length so that one can change the location of the specific limit for the second frame 24 to accommodate different sized wheels.

Other embodiments are possible. For example, the first frame 22 may not include a cavity 28 into which a portion of the wheel 60 is inserted when the device 20 holds the wheel. Instead, the first frame 22 may include a bottom 108 that is flush with the loop 100, and may include a mount that positions the first frame above the floor and to which the floor of a bus or train is coupled. As another example, the first frame 22 may include a U-channel or V-channel component that receives the wheel, instead of the loop 100.

FIG. 6 shows two perspective views of a device 120, each according to another embodiment of the invention. The device 120 is similar to the device 20 shown and discussed in conjunction with FIGS. 1-5, except the device 120 also includes a pedestal 122 coupled with the first frame 124. The pedestal 122 positions the first frame 124, the second frame 126 and the lock 128 a distance above the floor of a bus or train that the device 120 may be mounted in. Elevating the first frame 124 above the floor that the device 120 is mounted to reduces the footprint of the device 120 and the cycle it holds, on the bus or train's floor and allows more room for passengers to walk or stand on the bus or train's floor, or for seats to be located. The device 120 may also include a ramp 130 (shown in one of the views) that allows one to roll one's wheel up to the first frame 124.

The pedestal 122 may be configured as desired. For example, in this and other embodiments, the pedestal 122 includes a first pole 132, and a second pole 134 that lies within the first pole 132 and slides relative to the first pole 132. The first pole 132 may be mounted to a bus or train's floor to mount the device 120 in the bus or train for use. The second pole 134 is coupled with the device's first frame 124. To increase or decrease the distance between the device's first frame 124 and the bus or train's floor, one slides the second pole 134 relative to the first pole 132 and then locks the second pole 134 in the desired position. A collar (not shown) may be used to lock the second pole 134 to the first pole 132 and prevent the second pole 134 from sliding relative to the first pole 132. The collar may be mounted on the first pole and may be manipulated to increase or decrease friction between the collar and the second pole 134.

Each of FIGS. 7A and 7B shows a perspective view of another lock 140, according to an embodiment of the invention. FIG. 7A shows the lock 140 in a position ready to engage a cycle's wheel (similar to the position of the lock 26 shown in FIG. 2A). FIG. 7B shows the lock 140 in a position that would engage the wheel (not shown here) while the wheel is in the first frame 22 (not shown here) and the second frame 24 is in the second position (similar to the position of the lock 26 shown in FIG. 2C). The lock 140, like the lock 26, allows a cycle's wheel (not shown) to rotate in the direction indicated by the arrow 66, but resists the roll of the cycle's wheel in the direction indicated by the arrow 74.

In this and other embodiments, the lock 140 includes a wedge-shaped body 142 having a profiled contact-surface 144 that contacts the wheel when the lock 140 contacts the wheel. The lock 140 also includes two tracks 146 that hold the wedge-shaped body 142 and allow the body 142 to move relative to the second frame 24 when the body 142 is urged in the direction 66. Each of the tracks 146 are coupled with the second frame such that each can rotate relative to the second frame 24, but not translate relative to the second frame 24. While the profiled contact-surface 144 contacts the wheel and the wheel rotates in the direction 66 about the wheel's hub, the wheel pushes the wedge-shaped body 142 in the same direction 66, away from the second frame 24. Because the tracks 146 can rotate relative to the second frame 24, the wedge-shaped body 142 is moved out from between the wheel and the points 148 where the two tracks are coupled to the second frame 24. Pushed away from the points 148, the wedge-shaped body 142 does not substantially resist the rotation of the wheel in the direction 66. But, while the wheel rotates in the direction 74 and the profiled contact-surface 144 contacts the wheel, the wheel pushes the wedge-shaped body 142 in the same direction 74. This causes the wedge-shaped body 142 to jamb between the wheel and the points 148, and thus resist the rotation of the wheel in the direction 74.

Other embodiments are possible. For example, the profiled contact-surface 144 may be configured to have a lower coefficient of friction wheel when the wheel rotates in the direction 66 than when the wheel rotates in the direction 74. As another example, the tracks 146 may coupled to the second frame 24 such that the points 148 at which the tracks 146 are coupled may be moved toward or away from the top 150 of the second frame 24.

Each of FIGS. 8A and 8B shows a perspective view of yet another lock 160, according to an embodiment of the invention. Similar to FIGS. 7A and 7B, FIG. 8A shows the lock 160 in a position ready to engage a cycle's wheel (not shown) and FIG. 8B shows the lock 160 in a position that would engage the wheel while the wheel is in the first frame 22 (not shown here) and the second frame 24 is in the second position. The lock 160, like the lock 26, allows a cycle's wheel (not shown) to rotate in the direction indicated by the arrow 66, but resists the roll of the cycle's wheel in the direction indicated by the arrow 74.

In this and other embodiments, the lock 160 includes a body 162 having a contact-surface 164, and a pin 166 that the body 162 may rotate about. The body 162 is configured to locate the contact-surface 164 a distance away from the pin 166 that depends on the angular position of a line 168 that extends perpendicular from the pin's axis 170 to the contact-surface 164. While the wheel rotates in the direction 66 and the contact-surface 164 contacts the wheel, the wheel rotates the body 162 in the direction indicated by the arrow 172. This causes the contact-surface 164 to move away from the wheel and toward the pin 166, thus allowing the wheel to rotate in the direction 66. But, while the wheel rotates in the direction 74 and the contact-surface 164 contacts the wheel, the wheel rotates the body 162 in the direction indicated by the arrow 174. This causes the body 162 to jamb between the wheel and the pin 166, and thus resist the rotation of the wheel in the direction 74. In this manner, the lock 160 is similar to the lock 140 (FIGS. 7A and 7B) in that the body 162 jambs between the wheel and the pin 166 to resist the rotation of the wheel in the direction 74.

Other embodiments are possible. For example, like the lock 140, the contact-surface 164 may be configured to have a lower coefficient of friction when the wheel rotates in the direction 66 than when the wheel rotates in the direction 74.

Each of FIGS. 9A and 9B shows a view of still another lock 180, according to an embodiment of the invention. Both FIGS. 9A and 9B shows the lock 180 in a position ready to engage a cycle's wheel (similar to the position of the lock 26 shown in FIG. 2A). FIG. 9A shows a perspective view of the lock 180; and FIG. 9B shows a top view of the lock 180. The lock 180, like the lock 26, allows a cycle's wheel (not shown) to rotate in the direction indicated by the arrow 66, but resists the roll of the cycle's wheel in the direction indicated by the arrow 74.

In this and other embodiments, the lock 180 includes two flexible bodies 182 each coupled to a respective side of the second frame 24. The bodies 182 are coupled to the second frame such that together they form a V with the open end of the V facing the wheel as the wheel is about to be inserted into the first frame 22 (see FIGS. 2A and 9B). Each of the flexible bodies 182 includes a plurality of bristles 184 (only eleven labeled for clarity) to provide independent flexion to regions of the body 182. While the wheel rotates in the direction 66 and the flexible bodies 182 contact the wheel, the wheel pushes bristles 184 out of its way. This causes one or more bristles 184 to bend away from the other body 182 extending from the other side of the second frame 24, thus allowing the wheel to rotate in the direction 66. But, while the wheel rotates in the direction 74 and the flexible bodies 182 contact the wheel, the wheel pushes the bristles toward the other body 182 extending from the other side of the second frame 24. This causes the bristles 184 to jamb against the wheel, and thus resist the rotation of the wheel in the direction 74.

Other embodiments are possible. For example, the flexible bodies 182 may include a sheet of flexible material, instead of a plurality of bristles 184. As another example, the lock 180 may include a single flexible body 182, instead of two.

The preceding discussion is presented to enable a person skilled in the art to make and use the invention. Various modifications to the embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. A device for holding a cycle, the device comprising:
a first frame operable to hold a wheel of a cycle when the wheel is inserted into a cavity of the frame;
a second frame coupled with the first frame and moveable relative to the first frame to a first position to allow the cycle's wheel to be inserted into the first frame, and to a second position to hold the cycle's wheel in the first frame; and
a lock coupled with the second frame such that the lock contacts the cycle's wheel when the cycle's wheel is being inserted into the first frame and the second frame moves toward the second position, wherein the lock is configured to:
allow the insertion of the cycle's wheel into the first frame when the second frame moves toward the second position, and
resist the withdrawal of the cycle's wheel out of the first frame when the second frame is in the second position.

2. The device of claim 1 wherein the first frame includes a basket.

3. The device of claim 1 wherein the second frame includes a first rail and a second rail that together define a loop through which extends a portion of the cycle's wheel when the second frame is in the second position and holds the wheel in the first frame.

4. The device of claim 1 wherein the second frame is pivotally coupled to the first frame.

5. The device of claim 1 wherein the lock contacts the cycle's wheel when the cycle's wheel has been inserted into the first frame and the second frame is in the second position.

6. The device of claim 1 wherein the lock contacts the cycle's wheel when the cycle's wheel is being inserted into the first frame and the second frame moves toward the first position.

7. The device of claim 1 wherein the lock contacts the cycle's wheel while the cycle's wheel is being inserted into the first frame and the second frame moves to the second position.

8. The device of claim 1 wherein the lock contacts the cycle's wheel while the cycle's wheel is being inserted into the first frame and the second frame moves to the first position.

9. The device of claim 1 wherein:
the second frame includes a first end, and
the lock is coupled with the first end.

10. The device of claim 1 wherein the second frame includes a first end coupled with the lock, and a second end pivotally coupled with the first frame.

11. The device of claim 9 wherein as a cycle wheel is inserted into the first frame, the second frame rotates relative to the first frame such that the first end moves away from the first frame as the second frame moves toward the first position.

12. The device of claim 9 wherein as a cycle wheel is inserted into the first frame, the second frame rotates relative to the first frame such that the first end moves toward the first frame as the second frame moves toward the second position.

13. The device of claim 1 wherein the lock includes:
a contact wheel having a sprocket, the contact wheel operable to contact the cycle's wheel while the cycle's wheel is being inserted into the first frame and the second frame moves toward the second position, and
a pawl that engages the sprocket and is configured to:
allow the contact wheel to rotate in a first direction, and
prevent the contact wheel from rotating in a direction opposite the first direction.

14. The device of claim 1 further comprising a spring coupled to the first frame and the second frame, and operable to bias the second frame toward the second position.

15. The device of claim 1 further comprising a pedestal coupled with the first frame and configured to position the first frame above a floor.

16. The device of claim 15 wherein the pedestal is adjustable to change the distance between the first frame and the floor.

17. A method for holding a cycle, the method comprising:
moving a second frame of a device, which is coupled to a first frame of the device, to a first position to allow a wheel of a cycle to be inserted into the first frame;
moving the second frame of the device to a second position to hold the cycle's wheel in the first frame;
when moving the second frame toward the second position, contacting the cycle's wheel with a lock of the device that is coupled with the second frame;
while the lock contacts the cycle's wheel, allowing the cycle's wheel to be inserted into the first frame;
urging the lock against the cycle's wheel when the second frame is in the second position; and
with the lock, resisting the withdrawal of the cycle's wheel from the first frame.

18. The method of claim 17 wherein moving the second frame of the device to the first position includes pushing the second frame with the cycle's wheel.

19. The method of claim 17 wherein moving the second frame of the device to the first position includes rotating the second frame relative to the first frame.

20. The method of claim 17 wherein moving the second frame of the device to the second position includes rotating the second frame relative to the first frame.

21. The method of claim 17 wherein contacting the cycle's wheel with the lock includes contacting the cycle's wheel while moving the second frame to the second position.

22. The method of claim 17 further comprising contacting the cycle's wheel with the lock of the device when moving the second frame to the first position.

23. The method of claim 22 wherein contacting the cycle's wheel with the lock when moving the second frame to the first position, includes contacting the cycle's wheel while moving the second frame to the second position.

24. The method of claim 17 wherein allowing the cycle's wheel to be inserted into the first frame includes rotating a contact wheel of the lock in a first direction, wherein the contact wheel contacts the cycle's wheel.

25. The method of claim 17 wherein resisting the withdrawal of the cycle's wheel from the first frame includes the lock preventing the withdrawal of the cycle's wheel from the first frame.

26. The method of claim 24 wherein resisting the withdrawal of the cycle's wheel from the first frame includes preventing the lock's contact wheel from rotating in a second direction that is opposite the first direction.

27. The method of claim 17 further comprising moving the second frame away from the cycle's wheel that is held in the first frame, to withdraw the cycle's wheel out of the first frame.
